(19) United States
(12) Patent Application Publication
(10) Pub. No.: US 2008/0068432 A1
(43) Pub. Date: Mar. 20, 2008

(54) INKJET PRINTER AND PRINTING METHOD USING THE SAME

(75) Inventors: Dong-kee Sohn, Yongin-si (KR); Min-soo Kim, Yongin-si (KR); Mi-jeong Song, Yongin-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/688,393

(22) Filed: Mar. 20, 2007

(30) Foreign Application Priority Data
Sep. 20, 2006 (KR) 2006-91145

(51) Int. Cl. B41J 2/01

(52) U.S. Cl. 347/104

(57) ABSTRACT

An inkjet printer and a printing method using the inkjet printer. The inkjet printer to form an image on a single sheet of paper by performing a plurality of printing jobs on the paper includes a print head fixed to the inkjet printer to perform a printing job on the paper which moves relative to the print head, and a paper rotating member to rotate the paper on which printing job has been performed by the print head 90 degrees in a horizontal direction, wherein the paper fed to the print head in a first direction corresponding to the printing job to be performed by the print head, is rotated 90 degrees in a horizontal direction by the paper rotating member, and then the rotated paper is fed to the print head in a second direction opposite to the first direction and a printing job is repeatedly performed on the paper by the print head.

### CROSS-REFERENCE TO RELATED APPLICATIONS

This application claims priority under Korean Patent Application No. 10-2006-0091145, filed on Sep. 20, 2006, in the Korean Intellectual Property Office, the disclosure of which is incorporated herein in its entirety by reference.

### BACKGROUND OF THE INVENTION

1. Field of the Invention

The present general inventive concept relates to an inkjet printer, and more particularly, to an inkjet printer which can be used to provide a printed image having an improved image quality, and a printing method using the inkjet printer.

2. Description of the Related Art

A conventional inkjet printer is an apparatus that ejects minute ink droplets from an inkjet print head on desired positions of recording paper in order to print specific color images. Inkjet printers are classified into a shuttle type inkjet printer having a print head which is shuttled in a direction perpendicular to the direction of transporting a print medium to print an image, and a line printing type inkjet printer which has a page-wide array print head corresponding to the width of a print medium. The latter has been developed for high-speed printing. In the page-wide array print head, a plurality of inkjet print heads are formed in a predetermined arrangement. In the line printing type inkjet printer, the array print head is fixed and a print medium is transported, thereby allowing high-speed printing.

Inkjet print heads are categorized into two types according to the ink droplet ejection mechanism thereof. The first one is a thermal inkjet print head that ejects ink droplets due to an expansion force of ink bubbles generated by thermal energy. The other one is a piezoelectric inkjet print head that ejects ink droplets by a pressure applied to ink due to the deformation of a piezoelectric body.

A line printing type inkjet printer performs a printing job on the condition that an array print head is fixed in the inkjet printer. Thus, when a nozzle having a problem with ejecting ink from the print head chips included in the array print head exists, a white streak may be formed in a printed image. This problem can be relatively easily solved in a shuttle type inkjet print head in which a print head moves on a print medium and simultaneously performs a printing job. However, it is difficult to compensate for this problem in ejecting for the line printing type inkjet printer performing a printing job when the array print head is fixed. In order to solve this problem, one image may be formed by repeatedly performing the same print job. However, the quality of the image printed using this method can not be effectively improved.

### SUMMARY OF THE INVENTION

The present general inventive concept provides an inkjet printer which can be used to provide a printed image having an improved quality and a printing method using the inkjet printer.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept are achieved by providing an inkjet printer to form an image on a single sheet of paper by performing a plurality of printing jobs on the paper, including a print head which is fixed in the inkjet printer to perform a first printing job on the paper which moves relative to the print head, and a paper rotating member to rotate the paper on which the first printing job has been performed by the print head 90 degrees in a horizontal direction, wherein the paper which is fed to the print head in a first direction and on which the first printing job has been performed by the print head, is rotated 90 degrees in a horizontal direction by the paper rotating member, and then the rotated paper is fed to the print head in a second direction opposite to the first direction and a second printing job is performed on the rotated paper by the print head.

The print head may be an array print head, a width of which corresponds to a long side of the paper. The paper rotating member may include a rotating plate on which the paper, which is fed to the print head in the first direction and on which the first printing job has been performed by the print head, is loaded, and where the paper rotating member rotates the loaded paper by 90 degrees in a horizontal direction.

The foregoing and/or other aspects and utilities of the present general inventive concept may also be achieved by providing an inkjet printer to form an image on a single sheet of paper by performing a plurality of printing jobs on the paper, including a print head which is fixed to the inkjet printer to perform a first printing job on the paper which moves relative to the print head, a paper rotating member to rotate the paper on which a printing job has been performed by the print head 90 degrees in a horizontal direction, and a paper moving member to feed the rotated paper to the print head, wherein the paper, which i fed to the print head in a first direction and on which the first printing job has been performed by the print head, is rotated 90 degrees by the paper rotating member and is moved in a second direction opposite to the first direction, and then the paper is fed to the print head in the second direction by the paper moving member and a second printing job is performed by the print head.

The paper may be fed to a front of the print head, the paper rotating member may be disposed on a rear of the print head, and the paper moving member may be disposed on the front of the print head. The paper rotating member may include a paper rotating roller angled at 45 degrees in a horizontal direction in a lower portion of the print head, and wherein the paper moving member may include a paper rotating roller which is parallel to the print head in the lower portion of the print head.

The foregoing and/or other aspects and utilities of the present general inventive concept may also be achieved by providing an inkjet printer to form an image on a single sheet of paper by performing a plurality of printing jobs on the paper, including a first print head which is fixed to the inkjet printer to perform a first printing job on the paper which moves relative to the print head, and a second print head which is fixed perpendicular to the first print head in the inkjet printer to perform a second printing job on the paper, wherein the paper, which is fed to the first print head in a first direction and on which the first printing job has been performed by the print head, is fed to the second print head in a second direction perpendicular to the first direction and on which the second printing job is performed by the second print head.

One of the first and second print heads may be an array print head, a width of which corresponds to a long side of the paper, and the other of the first and second print heads may be an array print head, a width of which corresponds to a short side of the paper.

The foregoing and/or other aspects and utilities of the present general inventive concept may also be achieved by providing a printing method of forming an image on a single sheet of paper by performing a plurality of printing jobs on the paper using an inkjet printer, wherein the inkjet printer includes a print head which is fixed in the inkjet printer to perform the plurality of printing jobs on the paper which moves relative to the print head, and a paper rotating member to rotate the paper on which one of the plurality of printing jobs has been performed by the print head 90 degrees in a horizontal direction, the method including feeding the paper to the print head in a first direction and performing first printing job thereon, rotating the paper on which the first printing job has been performed 90 degrees in a horizontal direction by using the paper rotating member, and feeding the rotated paper to the print head in a second direction opposite to the first direction and performing a second printing job on the paper.

The foregoing and/or other aspects and utilities of the present general inventive concept may also be achieved by providing a printing method to form an image on a single sheet of paper using a plurality of printing jobs on the paper using an inkjet printer, wherein the inkjet printer includes a print head which is fixed in the inkjet printer to perform a plurality of printing jobs on a moving paper, a paper rotating member to rotate the paper on which one of the plurality of printing jobs has been performed by the print head 90 degrees in a horizontal direction, and a paper moving member to feed the rotated paper to the print head, the method including feeding the paper to the print head in a first direction and performing a first printing job, rotating the paper on which the first printing job has been performed 90 degrees in a horizontal direction by the paper rotating member and moving the paper in a second direction opposite to the first direction, moving the paper, which moves in the second direction, in the first direction by the paper moving member, and feeding a paper, which is moved in the first direction, to the print head and performing a second printing job on the paper.

The foregoing and/or other aspects and utilities of the present general inventive concept may also be achieved by providing a printing method of forming one image on a single sheet of paper by performing a plurality of printing jobs on the paper using an inkjet printer, wherein the inkjet printer includes a first print head which is fixed to the inkjet printer to perform a first printing job on the paper which moves relative to the print head, and a second print head which is perpendicular to the first print head to perform a second printing job, the method including feeding the paper to the first print head in a first direction and performing the first printing job, and feeding the paper on which the first printing job has been performed to the second print head in a second direction perpendicular to the first direction and performing the second printing job on the paper.

The foregoing and/or other aspects and utilities of the present general inventive concept may also be achieved by providing an inkjet printer to form an image on a single sheet of paper, including a print head to perform a first printing job on the paper as the paper moves in a first direction, and a paper rotating member to rotate the paper on which the first printing job has been performed and to provide the rotated paper back to the print head to perform a second printing job on the rotated paper as the rotated paper moves in a second direction.

The inkjet printer may further include a paper moving member to move the paper in the first direction and the second direction.

The foregoing and/or other aspects and utilities of the present general inventive concept may also be achieved by providing an inkjet printer to form an image on a single sheet of paper, including a paper moving member to move the paper in a plurality of directions, a print head to perform a first printing job on the paper when the paper moving member moves the paper in a first direction, and a paper rotating member to rotate the paper on which the first printing job has been performed, such that the paper moving member moves the rotated paper in a second direction such that the print head performs a second printing job on the rotated paper.

The foregoing and/or other aspects and utilities of the present general inventive concept may also be achieved by providing an inkjet printer to form an image on a single sheet of paper, including a first print head to perform a printing job on the paper as the paper moves in a first direction, a paper rotating member to rotate the paper on which the first printing job has been performed, and a second print head to perform a second printing job on the rotated paper as the rotated paper moves in a second direction.

The foregoing and/or other aspects and utilities of the present general inventive concept may also be achieved by providing an inkjet printer to form an image on a recording medium, including a paper moving member to move the recording medium in a plurality of directions, and a print head to perform a printing job on the recording medium each time the paper moving member moves the recording medium in a different one of the plurality of directions.

The foregoing and/or other aspects and utilities of the present general inventive concept may also be achieved by providing a method of printing an image onto an inkjet printer, the method including moving the paper in a first direction and printing the image onto the paper, rotating the paper, and moving the rotated paper and printing the image again onto the paper.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a schematic view of an inkjet printer according to an embodiment of the present general inventive concept;

FIGS. 2A and 2B are views of array print heads which can be used as a print head of FIG. 1, according to an embodiment of the present general inventive concept;

FIGS. 3A through 3C are views illustrating a printing method using an inkjet printer of FIG. 1, according to an embodiment of the present general inventive concept;

FIG. 4 is a schematic view of an inkjet printer according to another embodiment of the present general inventive concept;

FIGS. 5A through 5G are views illustrating a printing method using an inkjet printer of FIG. 4, according to another embodiment of the present general inventive concept;

FIG. 6 is a schematic view of an inkjet printer according to another embodiment of the present general inventive concept; and

FIGS. 7A and 7B are views illustrating a printing method using an inkjet printer of FIG. 6, according to another embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

According to various embodiments of the present general inventive concept, an inkjet printer forms one image by printing a plurality of times on a single sheet of paper.

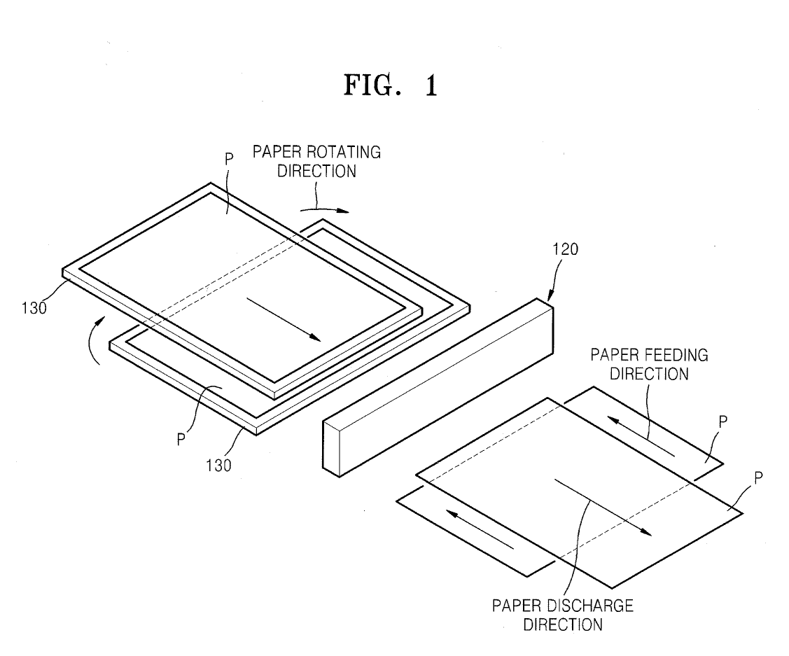

FIG. 1 is a schematic view of an inkjet printer according to an embodiment of the present general inventive concept.

Referring to FIG. 1, according to the current embodiment of the present general inventive concept, the inkjet printer includes a print head 120 to perform a printing job on a sheet of paper P and a paper rotating member to rotate the paper P by 90 degrees after performing the printing job. The print head 120 is fixed in the inkjet printer and performs the printing job on the paper P. The print head 120 may be an array print head having a width corresponding to a long side of the paper P.

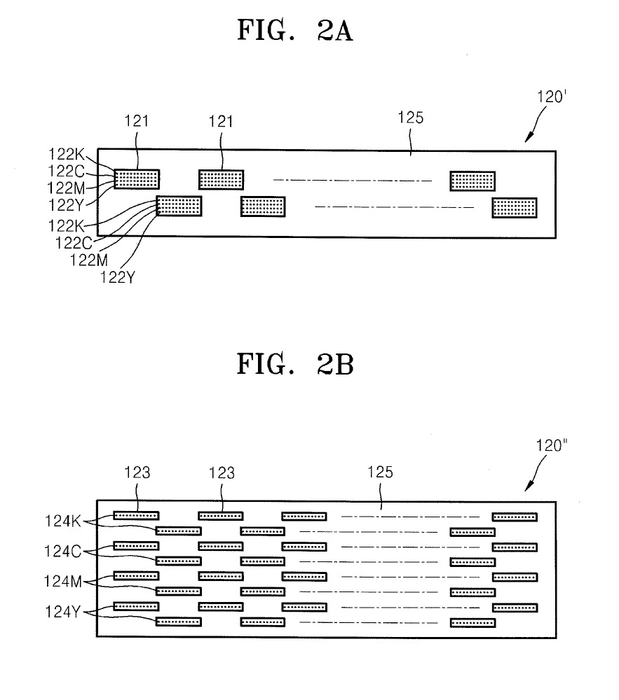

FIG. 2A is a view of an array print head 120′ which is can be used as the print head 120 of FIG. 1, according to an embodiment of the present general inventive concept. FIG. 2A illustrates a bottom surface of the array print head 120′. Referring to FIG. 2A, the array print head 120′ includes a plurality of print head chips 121 formed to alternate between two rows on an ink path member 125. A plurality of nozzles 122K, 122C, 122M and 122Y to eject black K, cyan C, magenta M and yellow Y ink, respectively, are formed in each of the print head chips 121. Alternatively, if the inkjet printer is a mono inkjet printer, a plurality of nozzles to eject only black K ink may be formed in each of the print head chips 121. FIG. 2B is a view of another array print head 120″ which can be used as the print head 120 of FIG. 1, according to an embodiment of the present general inventive concept. Referring to FIG. 2B, a plurality of print head chips 123 are formed in eight rows on an ink path member 125. The print head chips 123 may include one of nozzles 122K, 122C, 122M and 122Y to eject black K, cyan C, magenta M and yellow Y ink, respectively, wherein two rows of each of the print head chips 123 are employed to eject one of the four inks.

FIGS. 2A and 2B illustrate two types of array print heads to be used in an embodiment of the present general inventive concept. It will be understood by those of ordinary skill in the art that array print heads including print head chips arranged in various forms may be used. As stated above, according to an embodiment of the present general inventive concept, the array print head may have the width corresponding to the long side of a paper and may be fixed in the inkjet printer. However, the print head is not limited to this array print head. For example, the print head may have a width smaller than the long side of the paper and may be fixed in the inkjet printer.

The paper rotating member can rotate the paper P which is printed on by the print head 120 by 90 degrees. The paper rotating member may include a rotating plate 130. The paper P printed on by the print head 120 can be loaded on the rotating plate 130. The rotating plate 130 can rotate the loaded paper P by 90 degrees.

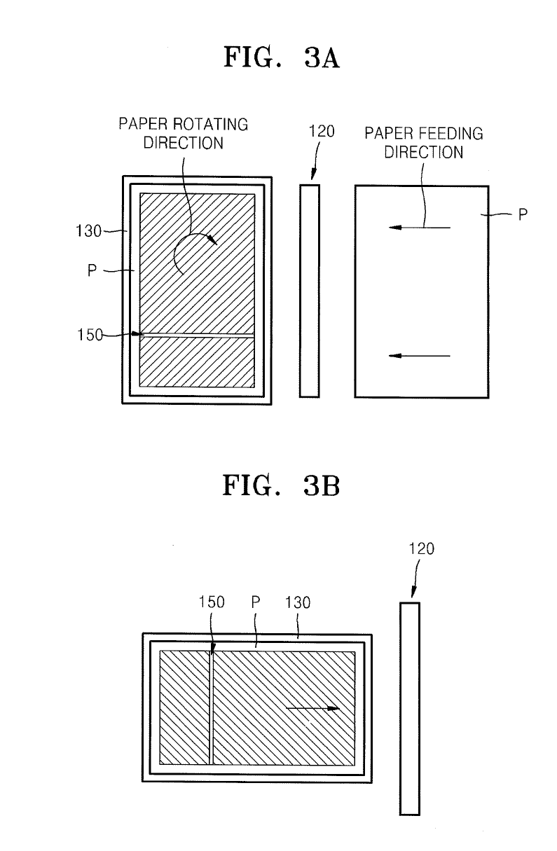

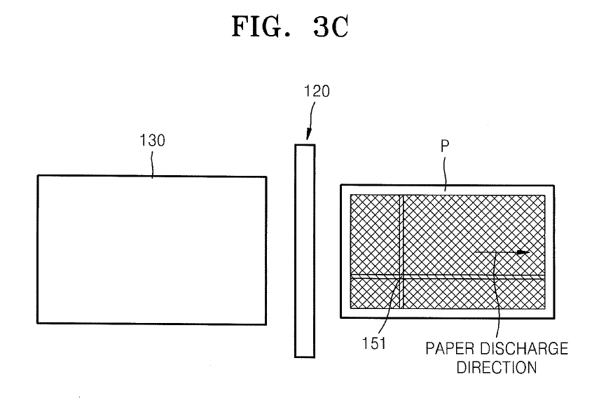

Hereinafter, a printing method using the inkjet printer of FIG. 1 will be described. FIGS. 3A through 3C are views illustrating a printing method using the inkjet printer of FIG. 1, according to an embodiment of the present general inventive concept.

Referring to FIG. 3A, a sheet of paper A is fed to a print head 120 in a first direction which is a paper feeding direction. The print head 120 performs a first printing job on the fed paper P. A long side of the paper P is first fed to the print head 120. A width of the print head 120 corresponds to the long side of the paper P. The paper printed on by the print head 120 may be loaded on the rotating plate 130. Referring to FIG. 3A, during the first printing job, when a nozzle has a problem ejecting ink from the print head 120, a white streak 150 which deteriorates image quality may be formed in a printed image.

Referring to FIG. 3B, the rotating plate 130 may be rotated in a horizontal direction by 90 degrees. Thus, the paper P which is printed on during the first printing job may be rotated in a horizontal direction by 90 degrees. The paper P which is printed on during the first printing job and which is currently rotated may be again fed to the print head 120 in a second direction which is opposite to the first direction and is a paper discharge direction. Accordingly, a short side of the paper P printed in the first printing job is fed to the print head 120.

Referring to FIG. 3C, the print head 120 may perform a second printing job on the printed paper P. The paper P printed on in the second printing job may be discharged in the second direction which is the paper discharge direction. The white streak 150 formed on the image by the first printing job may be reduced to a white dot 151 during the second printing job. Since the white dot 151 is too minute to be distinguished by human eyes, the white dot 151 does not badly affect the printing image quality.

According to an embodiment of the present general inventive concept, the long side of the paper P is first fed into the print head 120 during the first printing job. Then, the short side of the paper P is fed into the print head 120 during the second printing job. However, the present general inventive concept is not limited to this order of feeding of the paper P. That is, the short side of the paper P can be first fed into the print head 120 during the first printing job. Then, the long side of the side of the paper P can be fed into the print head 120 during the second printing job. In addition, according to the current embodiment of the present general inventive concept, two printing jobs may be performed on the paper P in order to form one image. However, the present general inventive concept is not limited to only two printing jobs. That is, three or more printing jobs may be performed on the paper.

As described above, according to the various embodiments of the present general inventive concept, the inkjet printer may repeatedly perform printing jobs in directions perpendicular to each other. Thus, a deterioration of image quality, which may occur when a nozzle has a problem ejecting ink from the print head 120, can be prevented.

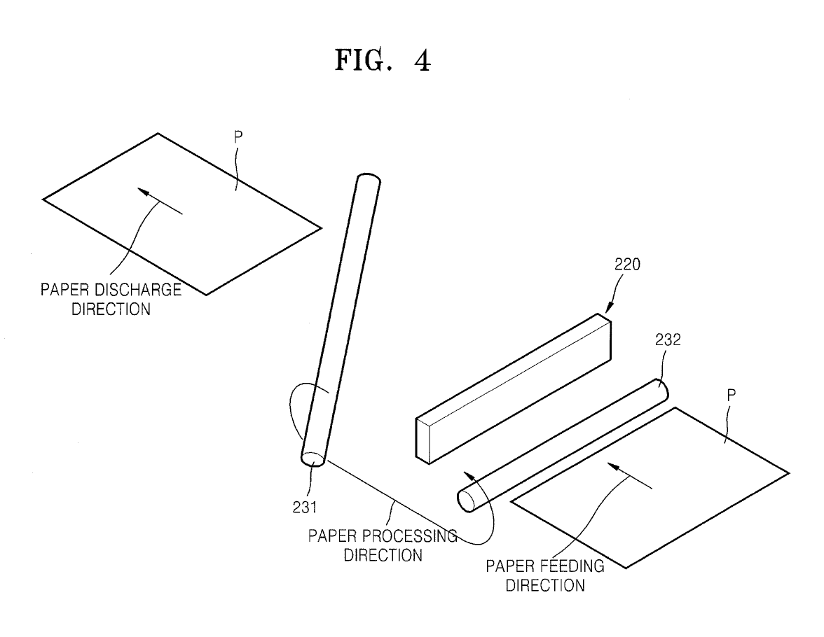

FIG. 4 is a schematic view of an inkjet printer according to another embodiment of the present general inventive concept.

Referring to FIG. 4, according to this embodiment, the inkjet printer includes a print head 220 to perform a printing job on a sheet of paper P, a paper rotating member (e.g., a paper rotating roller 231) to rotate the paper P by 90 degrees after performing the printing job, and a paper moving member (e.g., a paper moving roller 232) to again feed the rotated paper P to the print head 220. The print head 220 is fixed in the inkjet printer and performs the printing job on the fed paper P. An array print head having a width corresponding to a long side of the paper P can be used as the print head 220. The array print head may include a plurality of print head chips arranged in a predetermined form. Nozzles to eject ink having predetermined colors may be formed in each of the plurality of print head chips.

When the paper P is fed to a front portion of the print head 220, the paper rotating roller 231 may be formed on a rear portion of the print head 220, and the paper moving roller 232 may be formed on the front portion of the print head 220. The paper rotating roller 231 may be angled at 45 degrees in a horizontal direction at a lower portion of the print head 220. In addition, the paper moving roller 232 may be parallel to the print head 220 in the lower portion of the print head 220.

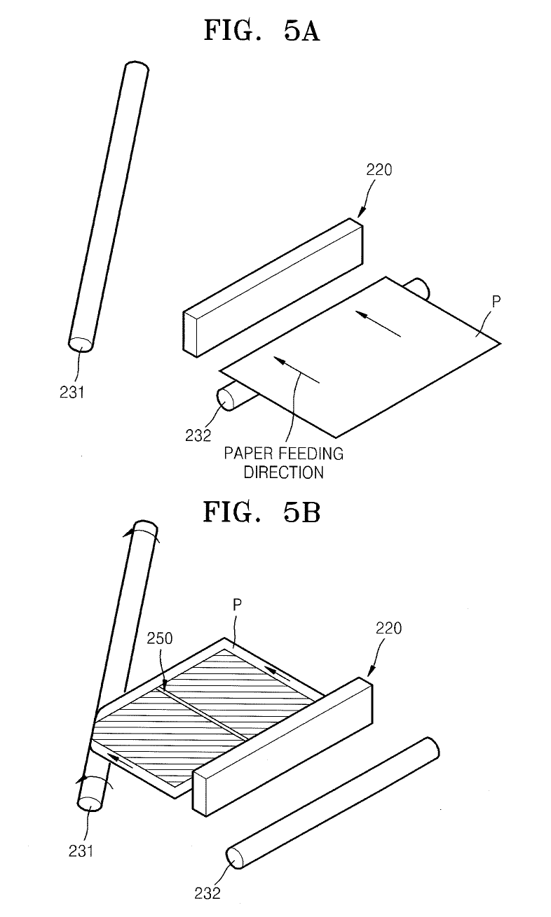

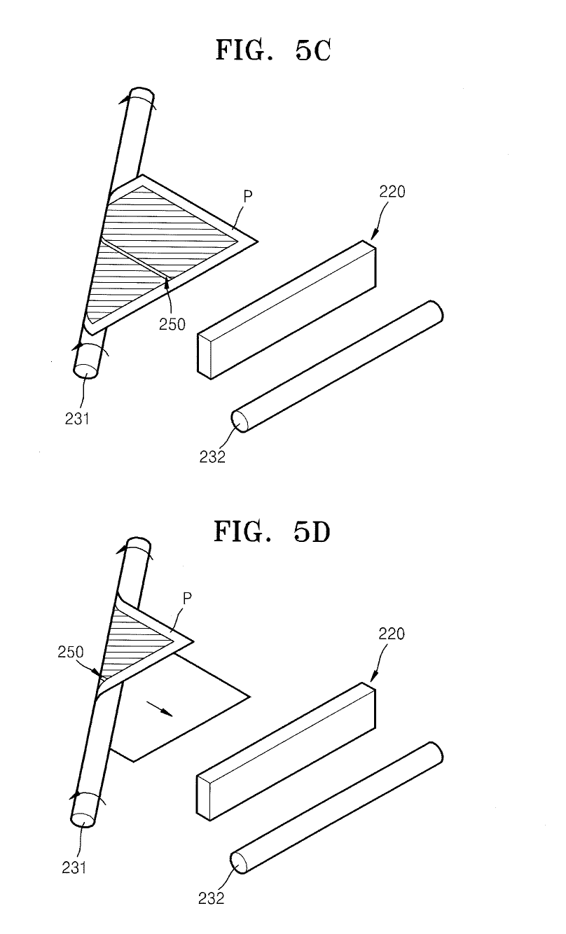

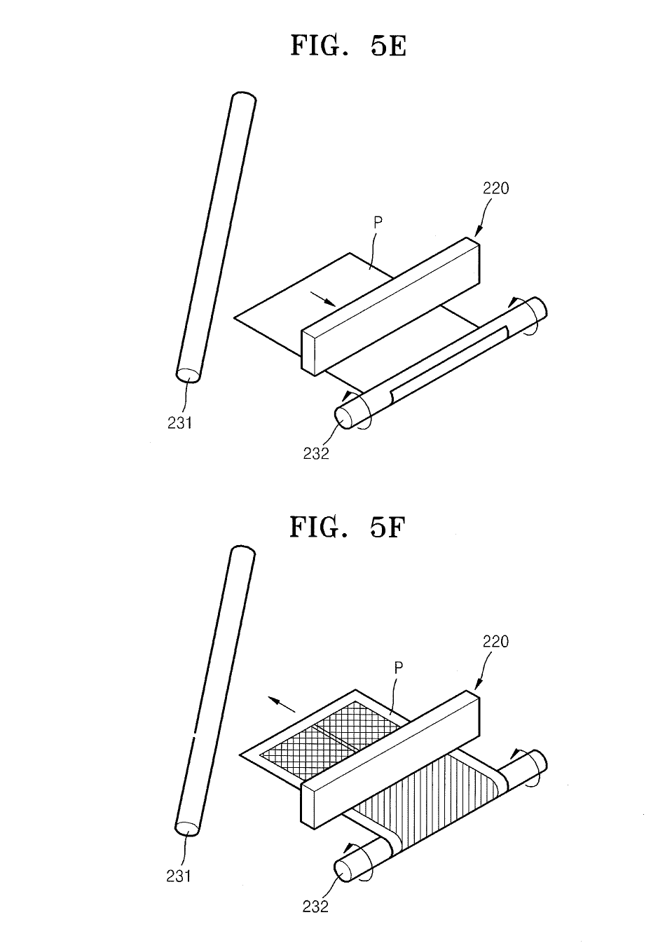

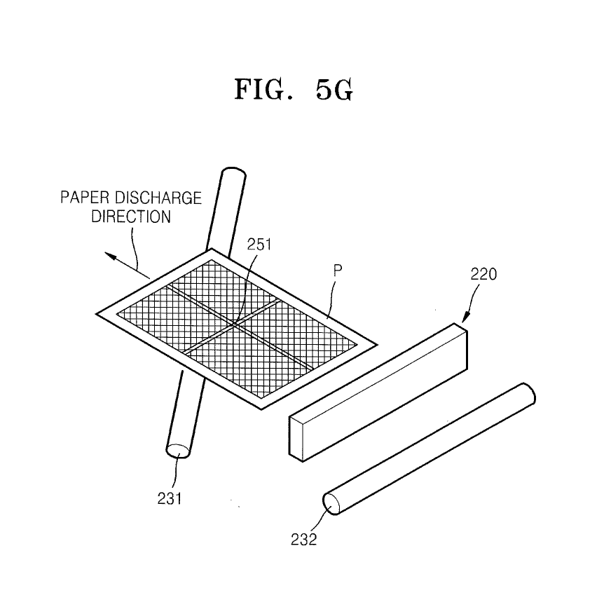

Hereinafter, a printing method using the inkjet printer of FIG. 4 will be described. FIGS. 5A through 5G are views illustrating a printing method using the inkjet printer of FIG. 4, according to another embodiment of the present general inventive concept.

Referring to FIG. 5A, a sheet of paper P is fed to a print head 220 in a first direction which is a paper feeding direction. The print head 220 performs a first printing job on the fed paper P. A long side of the paper P is first fed to the print head 220. A width of the print head 220 corresponds to the long side of the paper P. Referring to FIG. 5B, during the first printing job, when a nozzle has a problem ejecting ink from the print head, a printed image may include a white streak 250 which deteriorates image quality.

Referring to FIGS. 5B, 5C and 5D, when the paper P, which is printed on during the first printing job by the print head 220 and which is moved in a first direction, comes in contact with a paper rotating roller 231, the paper rotating roller 231 is rotated. The paper P, which is printed on during the first printing job, is rotated to move in a second direction opposite to the first direction by the rotation of the paper rotating roller 231. During the first printing job, since the paper rotating roller 231 is angled in a horizontal direction at 45 degrees with respect to the print head 220, the paper, which is printed on during the first printing job and which moves in the first direction, is rotated by 90 degrees by the paper rotating roller 231 and is simultaneously moved in the second direction.

Referring to FIG. 5E, when the paper which is moved in the second direction by the paper rotating roller 231 is in contact with the paper moving roller 232, the paper moving roller 232 is rotated. The paper P which is moved in the second direction by the rotation of the paper rotating roller 231 is moved in the first direction opposite to the second direction by the paper moving roller 232.

Referring to FIG. 5F, the paper P, which has been printed on during the first printing job and which is moved in the first direction by the paper moving roller 232, is again fed to the print head 220, and the print head 220 performs a second printing job on the paper P which has already been printed on during the first printing job. During the second printing job, a short side of the paper P is first fed to the print head 220.

Referring to FIG. 5G, the print head 220 performs the second printing job. The paper P, which is printed on during the second printing job, is discharged in the first direction, which is a paper discharge direction. During the second printing job, the white streak 250 formed during the first printing job is reduced to a minute white dot 251.

According to this embodiment of the present general inventive concept, the long side of the paper P is first fed into the print head 220 during the first printing job. Then, the short side of the paper P is fed into the print head 220 during the second printing job. However, the present general inventive concept is not limited to this order. That is, the short side of the paper P can be first fed into the print head 220 during the first printing job. Then, the long side of the side of the paper P can be fed into the print head 220 during the second printing job. In addition, according to the current embodiment of the present general inventive concept, two printing jobs can be performed on the paper P in order to form one image. However, the present general inventive concept is not limited to performing only two printing jobs. That is, three or more printing jobs may be performed on the paper.

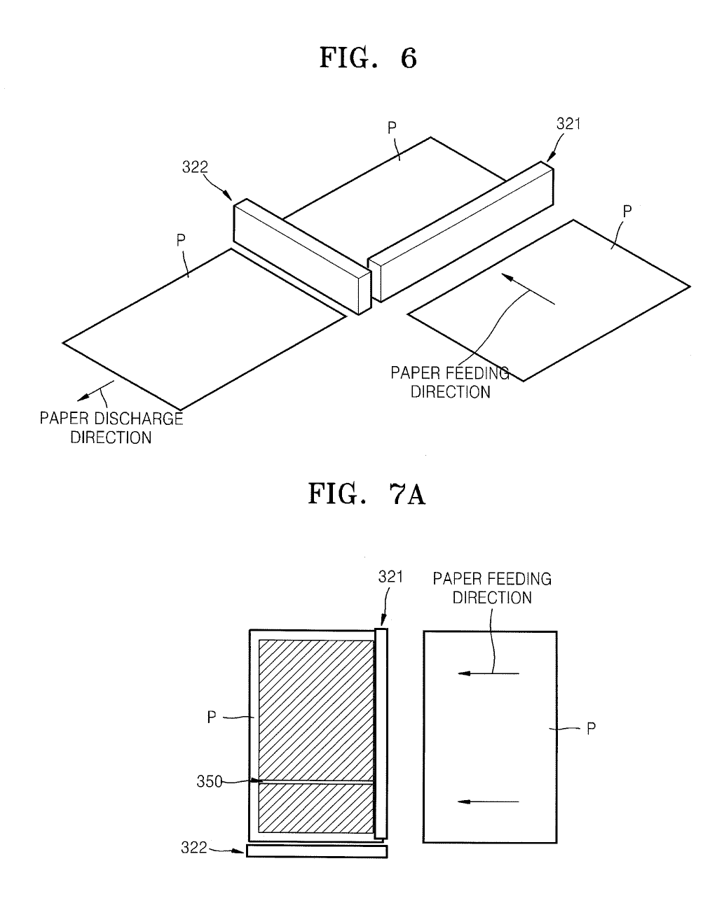

FIG. 6 is a schematic view of an inkjet printer according to another embodiment of the present general inventive concept.

Referring to FIG. 6, according to this embodiment, the inkjet printer includes a first print head 321 to perform a printing job on a paper P and a second print head 322 formed perpendicular to the first print head 321 to perform another printing job. The first print head 321 and the second print head 322 are fixed in the inkjet printer. The first print head 321 may have a width corresponding to a long side of the paper P. The second print head 322 may have a width corresponding to a short side of the paper P. The first print head 321 and the second print head 322 may be array print heads having a plurality of print head chips arranged in a predetermined form. Nozzles to eject ink having predetermined colors can be formed in each of the plurality of print head chips.

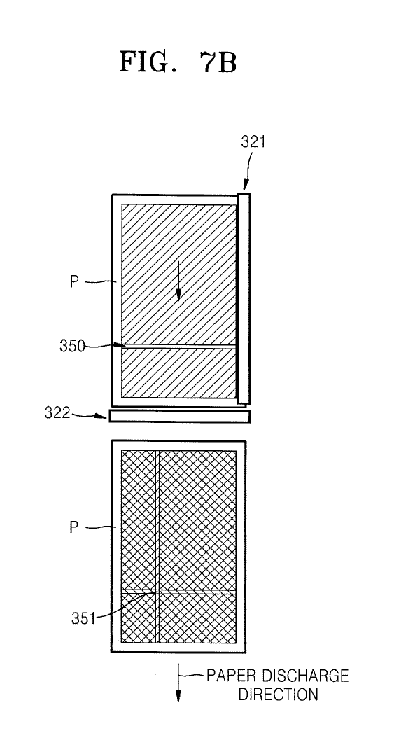

Hereinafter, a printing method using the inkjet printer of FIG. 6 will be described. FIGS. 7A and 7B are views illustrating a printing method using the inkjet printer of FIG. 6, according to another embodiment of the present general inventive concept.

Referring to FIG. 7A, a sheet of paper P may be fed to a first print head 321 in a first direction which is a paper feeding direction. The first print head 321 performs a first printing job on the fed paper P. A long side of the paper P may be first fed to the first print head 321. A width of the first print head 321 corresponds to the long side of the paper P. During the first printing job, when a nozzle has a problem ejecting ink from the first print head 321, a white streak 350 that deteriorates image quality may be formed in a printed image.

Referring to FIG. 7B, the paper P printed on during the first printing job by the first print head 321 is fed to a second print head 322 perpendicular to the first print head 321. Accordingly, the paper P, which is fed in the first direction and printed on during the first printing job, is fed in a second direction which is perpendicular to the first direction. Here, the short side of the paper P printed using the first printing job is first fed to the second print head 322. The second print head 322 performs a second printing job on the paper P which has already been printed on during the first printing job. The paper P which has been printed on during the second printing job is discharged in the second direction which is a paper discharge direction. During the second printing job, when a nozzle has a problem ejecting ink from the second print head 322, a white streak 350 which is formed on the image printed during the first printing job is reduced to a minute white dot 351.

According to the current embodiment of the present general inventive concept, widths of the print heads 321 and 322 may correspond to the long and short sides of paper P, respectively. However, the present general inventive concept is not limited to these arrangements. That is, widths of the print heads 321 and 322 may correspond to the short and long sides of paper P, respectively. Here, the short side of the paper P can be first fed to the first print head 321 during the first printing job. Then, the long side of the paper P can be fed to the second print head 322 during the second printing job. In addition, according to the current embodiment of the present general inventive concept, two printing jobs may be performed on the paper P in order to form one image. However, the present general inventive concept is not limited to this number of printing jobs. That is, three or more printing jobs may be performed on the paper P.

As described above, according to the embodiments of the present general inventive concept, an inkjet printer may repeatedly perform printing jobs in directions perpendicular to each other. Thus, a deterioration of image quality, which may occur when a nozzle has a problem ejecting ink from the print head, can be prevented using a minimum number of printing jobs.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An inkjet printer to form an image on a single sheet of paper by performing a plurality of printing jobs on the paper, comprising:
a print head fixed in the inkjet printer to perform a first printing job on the paper which moves relative to the print head; and
a paper rotating member to rotate the paper on which the first printing job has been performed by the print head 90 degrees in a horizontal direction,
wherein the paper fed to the print head in a first direction and on which the first printing job has been performed by the print head, is rotated 90 degrees in a horizontal direction by the paper rotating member, and then the rotated paper is fed to the print head in a second direction opposite to the first direction and a second printing job is performed on the rotated paper by the print head.

2. The inkjet printer of claim 1, wherein the print head is an array print head, a width of which corresponds to a long side of the paper.

3. The inkjet printer of claim 1, wherein the paper rotating member comprises:
a rotating plate on which the paper fed to the print head in the first direction and on which the first printing job has been performed by the print head, is loaded,
wherein the paper rotates the member rotating a loaded paper by 90 degrees in a horizontal direction.

4. An inkjet printer to form an image on a single sheet of paper by performing a plurality of printing jobs on the paper, comprising:
a print head fixed to the inkjet printer to perform a first printing job on the paper which moves relative to the print head;
a paper rotating member to rotate the paper on which a printing job has been performed by the print head 90 degrees in a horizontal direction; and
a paper moving member to feed the rotated paper to the print head,
wherein the paper fed to the print head in a first direction and on which the first printing job has been performed by the print head, is rotated 90 degrees by the paper rotating member and is moved in a second direction opposite to the first direction, and then the paper is fed to the print head in the second direction by the paper moving member and a second printing job is performed by the print head.

5. The inkjet printer of claim 4, wherein the print head is an array print head, a width of which corresponds to a long side of the paper.

6. The inkjet printer of claim 4, wherein:
the paper is fed to a front of the print head,
the paper rotating member is disposed on a rear of the print head, and
the paper moving member is disposed on the front of the print head.

7. The inkjet printer of claim 6, wherein the paper rotating member comprises:
a paper rotating roller angled at 45 degrees in a horizontal direction in a lower portion of the print head,
wherein the paper moving member comprises a paper rotating roller parallel to the print head in the lower portion of the print head.

8. An inkjet printer to form an image on single sheet of paper by performing a plurality of printing jobs on the paper, comprising:
a first print head fixed to the inkjet printer to perform a first printing job on the paper which moves relative to the print head; and
a second print head fixed perpendicular to the first print head in the inkjet printer to perform a second printing job on the paper,
wherein the paper fed to the first print head in a first direction and on which the first printing job has been performed by the print head, is fed to the second print head in a second direction perpendicular to the first direction and on which the second printing job is performed by the second print head.

9. The inkjet printer of claim 8, wherein one of the first and second print heads is an array print head, a width of which corresponds to a long side of the paper, and the other of the first and second print heads is an array print head, a width of which corresponds to a short side of the paper.

10. A printing method of forming an image on a single sheet of paper by performing a plurality of printing jobs on the paper using an inkjet printer, wherein the inkjet printer comprises a print head fixed in the inkjet printer to perform the plurality of printing jobs on the paper which moves relative to the print head, and a paper to rotate member rotating the paper on which one of the plurality of printing jobs has been performed by the print head 90 degrees in a horizontal direction, the method comprising:
feeding the paper to the print head in a first direction and performing a first printing job thereon;
rotating the paper on which the first printing job has been performed 90 degrees in a horizontal direction by using the paper rotating member; and
feeding the rotated paper to the print head in a second direction opposite to the first direction and performing a second printing job on the paper.

11. The method of claim 10, wherein the print head is an array print head, a width of which corresponds to a long side of the paper.

12. A printing method to form an image on a single sheet of paper using a plurality of printing jobs on the paper using an inkjet printer, wherein the inkjet printer comprises a print head fixed in the inkjet printer to perform a plurality of printing jobs on a moving paper, a paper rotating member to rotate the paper on which one of the plurality of printing jobs has been performed by the print head 90 degrees in a horizontal direction, and a paper moving member to feed the rotated paper to the print head, the method comprising:
feeding the paper to the print head in a first direction and performing a first printing job;
rotating the paper on which the first printing job has been performed 90 degrees in a horizontal direction by the paper rotating member and moving the paper in a second direction opposite to the first direction;
moving the paper, which moves in the second direction, in the first direction by the paper moving member; and
feeding a paper, which is moved in the first direction, to the print head and repeatedly performing a second printing job on the paper.

13. The method of claim 12, wherein the print head is an array print head, a width of which corresponds to a long side of the paper.

14. The method of claim 12, wherein:
the paper is fed to a front of the print head,
the paper rotating member is disposed on a rear of the print head, and
the paper moving member is disposed on the front of the print head.

15. The method of claim 14, wherein:
the paper rotating member comprises a paper rotating roller angled at 45 degrees in a horizontal direction in the lower portion of the print head, and
the paper moving member comprises a paper rotating roller parallel to the print head in the lower portion of the print head.

16. A printing method of forming one image on a single sheet of paper by performing a plurality of printing jobs on the paper using an inkjet printer, wherein the inkjet printer comprises a first print head fixed to the inkjet printer to perform a first printing job on the paper which moves relative to the print head, and a second print head which is perpendicular to the first print head to perform a second printing job, the method comprising:
feeding the paper to the first print head in a first direction and performing the first printing job; and
feeding the paper on which the first printing job has been performed to the second print head in a second direction perpendicular to the first direction and performing the second printing job on the paper.

17. The inkjet printer of claim 16, wherein:
one of the first and second print heads is an array print head, a width of which corresponds to a long side of the paper, and
the other of the first and second print heads is an array print head, a width of which corresponds to a short side of the paper.

18. An inkjet printer to form an image on a single sheet of paper, comprising:
a print head to perform a first printing job on the paper as the paper moves in a first direction; and
a paper rotating member to rotate the paper on which the first printing job has been performed and to provide the rotated paper back to the print head to perform a second printing job on the rotated paper as the rotated paper moves in a second direction.

19. The inkjet printer of claim 18, further comprising:
a paper moving member to move the paper in the first direction and the second direction.

20. An inkjet printer to form an image on a single sheet of paper, comprising:
a paper moving member to move the paper in a plurality of directions;
a print head to perform a first printing job on the paper when the paper moving member moves the paper in a first direction; and
a paper rotating member to rotate the paper on which the first printing job has been performed, such that the paper moving member moves the rotated paper in a second direction such that the print head performs a second printing job on the rotated paper.

21. An inkjet printer to form an image on a single sheet of paper, comprising:
a first print head to perform a printing job on the paper as the paper moves in a first direction;
a paper rotating member to rotate the paper on which the first printing job has been performed; and
a second print head to perform a second printing job on the rotated paper as the rotated paper moves in a second direction.

22. An inkjet printer to form an image on a recording medium, comprising:
a paper moving member to move the recording medium in a plurality of directions; and
a print head to perform a printing job on the recording medium each time the paper moving member moves the recording medium in a different one of the plurality of directions.

23. A method of printing an image onto an inkjet printer, the method comprising:
moving the paper in a first direction and printing the image onto the paper;
rotating the paper; and
moving the rotated paper and printing the image again onto the paper.
